(19) United States
(12) Patent Application Publication
(10) Pub. No.: US 2018/0365550 A1
(43) Pub. Date: Dec. 20, 2018

(54) SYSTEMS, AND METHODS FOR DETECTING, COUNTING, AND TRACKING PEOPLE AND ASSETS

(71) Applicant: Flow Lighting, LLC, Grapevine, TX (US)

(72) Inventor: Gregory A.M. Brown, Reno, NV (US)

(73) Assignee: Flow Lighting, LLC, Grapevine, TX (US)

(21) Appl. No.: 16/066,591

(22) PCT Filed: Jan. 10, 2017
(86) PCT No.: PCT/IB2017/050114

§ 371 Date: Jun. 27, 2018

Related U.S. Application Data
(60) Provisional application No. 62/277,066, filed on Jan. 11, 2016.

(51) Int. Cl. G06M 11/00; G01V 8/10; G07C 9/00

(52) U.S. Cl. CPC G06M 11/00; G07C 9/00; G01V 8/10

(57) ABSTRACT

This disclosure includes light fixtures, sensors and controls, systems, and methods for monitoring, counting and managing people or asset flow and locations in and out of an area or areas of interest. Light beams are generated by visible or invisible light sources, fixtures and/or sensors installed in the area of interest, and people or asset flow, counts, direction, speed and other data are detected. Using wired or secure wireless communications these data are tracked, stored and/or acted upon using on-board logic and/or remote logic and software.

### CROSS REFERENCE TO RELATED APPLICATIONS

This application claims the benefit of U.S. Provisional Application No. 62/277,066, filed Jan. 11, 2016, which is incorporated by reference herein.

### BACKGROUND

### 1. Field of Invention

The present invention is generally related to monitoring and managing movement of people and/or assets, and more particularly, but not by way of limitation, to detecting, counting, and tracking people and/or assets at a point and/or area of interest.

### 2. Description of Related Art

Some of the most valuable data points for retailers, business owners, schools and security conscious facilities are data related to specific counts of customers or occupants in a store or in a facility. These data may relate to units of time, circulation within a space, loiter time, and specific locations of customers or occupants in a facility, and can be translated into much more meaningful analytics.

Smart lights, smart buildings, smart sensors, and similar applications can provide additional overlap of data and functions and can share these data to more accurately manage people, places, things, and energy. People counts, circulation, loiter time, locations, asset tracking, security data and more are available through these data. Real-time people counts can be used to adjust environmental data such as ventilation loads and lighting automatically, as well ensuring occupant comfort and satisfaction.

Monitoring and managing customer data in a specified area can provide many benefits, including boosting customer satisfaction, sales, optimizing staffing, marketing or advertising to customer target customers in an area, optimizing energy consumption, real-time distribution of coupons, responding to security and emergencies, etc.

Some of the current systems for people flow count and monitoring use basic on/off toggles or binary sensors with basic data loggers. These systems usually cannot yield accurate results and provide meaningful data to end-users. Other more sophisticated systems require multiple technologies in parallel with each other, have limitations on placement of the system, have high installation costs, or other disadvantages.

For example, one current solution for people flow counting uses passive infrared (PIR) sensors. A PIR system “paints” an area with a pattern of beams to detect people or animals, with the assistance of a pyroelectric technology with temperature adjustment. However, sudden light changes can trigger false counts in a PIR system. Further, a PIR system usually cannot distinguish two or more people walking together and count multiple people walking together as one person, because the sensors are binary and the beam patterns cannot distinguish any detail. Thus. PIR systems are more suitable for detecting occupancy rather than counting occupants.

Another current solution for people flow counting uses piezoelectric sensor mats in which mechanical pressure of a person stepping on a mat triggers a count. A timer can be used to eliminate over-counting caused by multiple steps on a given mat but not if people are passing each other in opposite directions. The size of the mat and mat design may be capable of determining direction of travel, but typically also requires algorithms and software to provide useable data. However, piezoelectric sensor mats are limited in that they can be only installed on the floor. Accuracy can also be a problem for a piezoelectric sensor mat systems because it can be difficult for the system to distinguish a human from other animals or objects.

As another example, video camera systems have also been used to count people flow. A typical video camera system for people flow counting uses image processing technics to subtract static background data and analyze the remaining pixels for objects. However, variations in lighting, clothing color, occlusions, and shadows can challenge the system. Also, video camera systems can undercount high flow rates by massing “blobs” of pixels together and counting several people in a close group as one person. With the requirement of complex computations, video camera systems also require high computing power and consumption of energy. Video cameras need to be mounted at specific heights and angles to function well and must be protected from strong temperature gradients and airflows that can reduce accuracy. Unfortunately at most building or entrances to spaces strong temperature gradients and airflows are typically present as weather, temperature, humidity, wind, moisture and other environmental factors are at peak exposure as doors are opened to the outside environment. Not all spaces are suitable for camera mounting requirements due to special limitations, building materials, and clearances needed to achieve required accuracy levels.

Current light curtains are typically utilized for safety purposes, such as protecting people from hazardous equipment, vehicles, or zones. They typically serve to protect personnel from injury and machines from damage by guarding points of operation, access, areas and perimeters. A safety light curtain uses a photoelectric transmitter that projects an array of synchronized, parallel infrared beams to a receiver unit. When an opaque object interrupts one or more beams in the sensing field, control logic of the light curtain send a stop signal to the guarded machine. Light curtains have not previously been used to count or manage people flow.

### SUMMARY

Some embodiments of the present systems comprise a photoelectric unit configured to transmit a light beam and a processor configured to determine whether an interruption of the light beam is caused by a targeted object (e.g., a person and/or object of specified type(s)) passing through the light beam and to count the number of persons and/or assets passing through the light beam in a direction during a period of time. In some embodiments, multiple beams are transmitted one or more transceivers, and interruptions of each beam are determined to whether caused by one or more persons or assets. From an interruption pattern of multiple light beams, the processor may determine the number, size (e.g., height, width), speed, and/or moving direction of persons and/or assets passing through the light beams. When multiple light beams are used, some embodiments of the present systems may be configured to determine whether multiple persons passes through the light beams, and/or the multiple persons are side by side, and/or in sequence.

The processor may perform its functions by executing instruction stored in a memory and/or real-time. In some embodiments, the photoelectric unit may be a transceiver configured to transmit a light beam and receive a reflected copy of the light beam or receive a light beam transmitted by another photoelectric unit. In some embodiments, the photoelectric unit is a transmitter and the system comprises a receiver to receive a light beam from the transmitter.

A light beam in the present systems may be infrared, visible, or invisible light beam, and/or may be generated by a light-emitting diode (LED) or other suitable sources. The light beam may be in any direction: horizontal, vertical, or in an arbitrary angle. Optionally but not required, some embodiments may also comprise a guiding structure, which may guide persons to pass through the light beam in a specified way, e.g., such that multiple persons can only pass through the light beam sequentially. The present systems may be installed at an entrance or exit of a structure, such as vestibule, an elevator entrance, an escalator loading and/or unloading point, stair wells, access doors, a room, a building, a plaza, a parking lot, or the like, to detect, count, and/or track people flow passing the entrance or exit.

Some embodiments of the present systems may use light beams, light planes, or light curtains, which may include a switch, relay, processor or other suitable device to log or register an interruption of the light beam by a targeted object (e.g., a person or object of specified type(s)). Some embodiments of the present systems may use a transmitter and a receiver that are separated from each other, and a targeted object moves between the transmitter and the receiver. Other embodiments use a transmitter and receiver on or in the ceiling (e.g., in the same housing or adjacent housings), without requiring a receiver or reflector on the floor. The transmitter on/in the ceiling emits the beam, and a corresponding receiver on/in the ceiling detects the reflected light beam reflected off the target when the target is hit by the beam and the beam reflects back to the corresponding receiver.

Some embodiments of the present systems may, by way of example and not limitation, may comprise a transceiver (i.e., a transmitter and a receiver in the same housing or in close proximity), configured to transmit a light beam and/or receive the light beam reflected off a target and/or a light beam transmitted by another transceiver. When a target (e.g., a person or an object) moves between the transceiver and a reflector (e.g., a floor, a wall, or a specially designed reflector), the light beam may be interrupted by the target. Any of these examples alone or in combination, and/or in combination with other systems can provide the data required to determine the count, moving direction, speed, and/or size of targets passing through a point of interest or in an area of interest.

Some embodiments of the present systems use transmitters with a specific frequency, light wave or other suitable channel isolation. which can only be received by the matched receiver to the transmitter. This matching of transmitters to receiver reduces errors, false data input from other light sources, temperature fluctuation issues and other error prone conditions which reduce effectiveness and accuracy of these systems.

Some embodiments of the present systems mat comprise two or more photoelectric transceivers, each configured to transmit and/or receive a light beam, and a processor, relay, switch, and/or other devices to determine whether an interruption of a first light beam is caused by a person passing through the first light beam, to determine whether an interruption of a second light beam is caused by the same person, and to determine a moving direction of the person based on relative positions of the first light beam and the second light beam. The two light beams may be positioned in a distance from each other such that a person passing through the light beams only interrupts one light beam at a given time. In some embodiments of the present systems, the two photoelectric transceivers are replaced by two pairs of transmitters and receivers, each configured to transmit/receive a light beam.

Some embodiments of the present systems may comprise a series of light curtains which are spaced at certain distances. If a light beam or series of beams are interrupted in one light curtain, and a correlating series of interruptions occurs within a close time proximity at a second light curtain, beam, or series of beams, the system may determine the same target(s) (e.g., person or objects) moving across a light beam, series of light beams and/or light curtains. Based on the determination(s), the system may determine a count, speed and direction of the target(s).

Some embodiments of the present methods comprise: transmitting a light beam at a photoelectric unit, determining whether an interruption of the light beam is caused by a target (e.g., a person or object) passing through the light beam, and/or counting the number of targets passing through the light beam in a direction during a period of time based on interruptions determined to be caused by a target. The determination of interruption of light beams and/or counting of persons passing through light beams may be performed by the processor which executes instructions stored in a memory unit.

Some embodiments of the present methods comprise: transmitting a plurality of light beams, determining whether a target interrupted two or more light beams sequentially, and/or determining a travel direction of the person. Some embodiments of the present methods also comprise determining a height, a location, and/or a traveling speed of a target based on an interruption pattern light beams.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments arc described above and others arc described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1 depicts a system for people and/or asset flow monitoring and/or management according to one embodiment of the present disclosure.

FIGS. 1A-1B depict systems for people and/or asset flow monitoring and/or management according to some embodiments of the present disclosure.

FIG. 2 depicts a system for people and/or asset flow monitoring and/or management with multiple light beams/signals according to one embodiment of the present disclosure.

FIGS. 2A and 2B depict a side view and a front view, respectively, of persons passing through a people and/or asset flow monitoring and/or management system according to one embodiment of the present disclosure.

FIG. 3 depicts a system for people and/or asset flow monitoring and/or management according to one embodiment of the present disclosure.

FIG. 4 depicts a top view of a system for people and/or asset flow monitoring and/or management with arrays of transmitters/receivers according to one embodiment of the present disclosure.

FIGS. 4A and 4B depict a side view and a front view, respectively, of persons passing through a people and/or asset flow monitoring and/or management system according to one embodiment of the present disclosure.

FIG. 5 depicts a top view of persons passing through a people and/or asset flow monitoring and/or management system according to one embodiment of the present disclosure.

FIG. 5A depicts a possible configuration and positioning of transmitters/receivers according to one embodiment of the present disclosure.

FIGS. 6A-6D depict various design patterns of light curtains for people and/or asset flow monitoring and/or management.

FIGS. 7A-7C depict various design patterns of light curtains for people and/or asset flow monitoring and/or management.

FIG. 8 depicts a system for people and/or asset flow monitoring and/or management using image capturing devices according to one embodiment of the present disclosure.

FIG. 9 depicts a system for people and/or asset flow monitoring and/or management inside an area of interest according to one embodiment of the present disclosure.

FIG. 10 is a flow diagram depicting a method for people and/or asset flow monitoring and/or management according to one embodiment of the present disclosure.

FIGS. 11 and 11A-11B are flow diagrams depicting a method for people and/or asset flow monitoring and/or management according to one embodiment of the present disclosure.

FIG. 12 depicts a system for people and/or asset flow monitoring and/or management according to one embodiment of the present disclosure.

FIG. 13 depicts a system to which data collected from systems for people and/or asset flow monitoring and/or management may be exported.

FIG. 14 depicts a system to which data collected from systems for people and/or asset flow monitoring and/or management may be exported.

### DETAILED DESCRIPTION OF ILLUSTRATIVE EMBODIMENTS

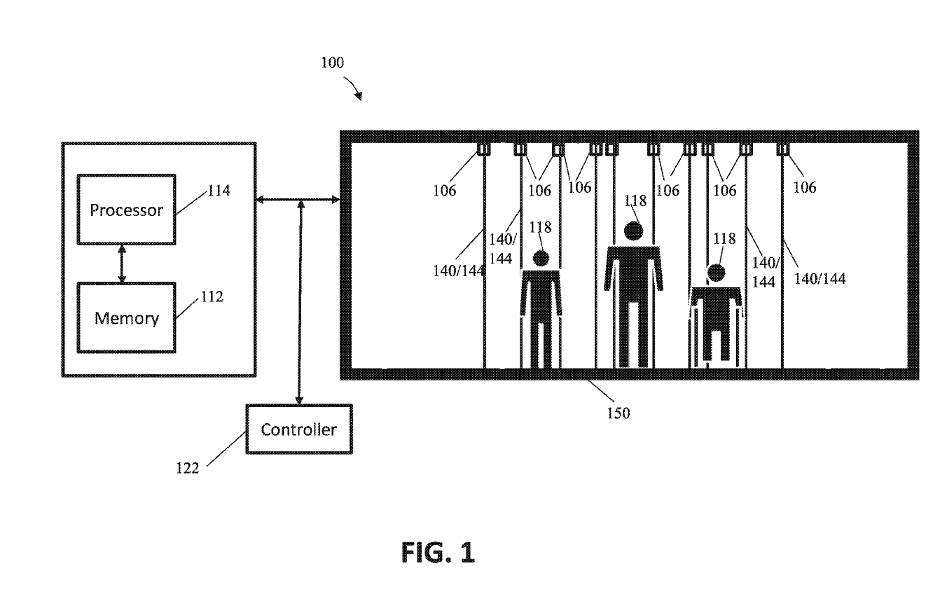

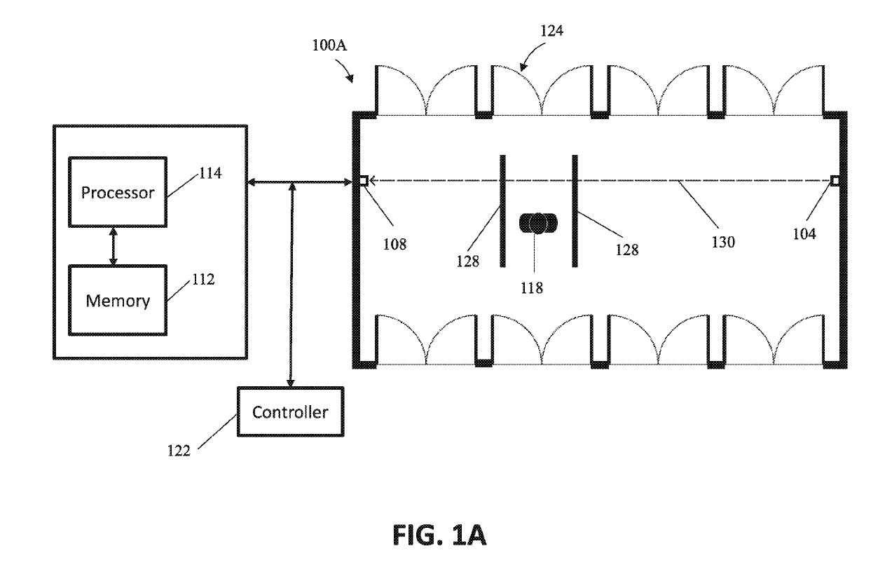

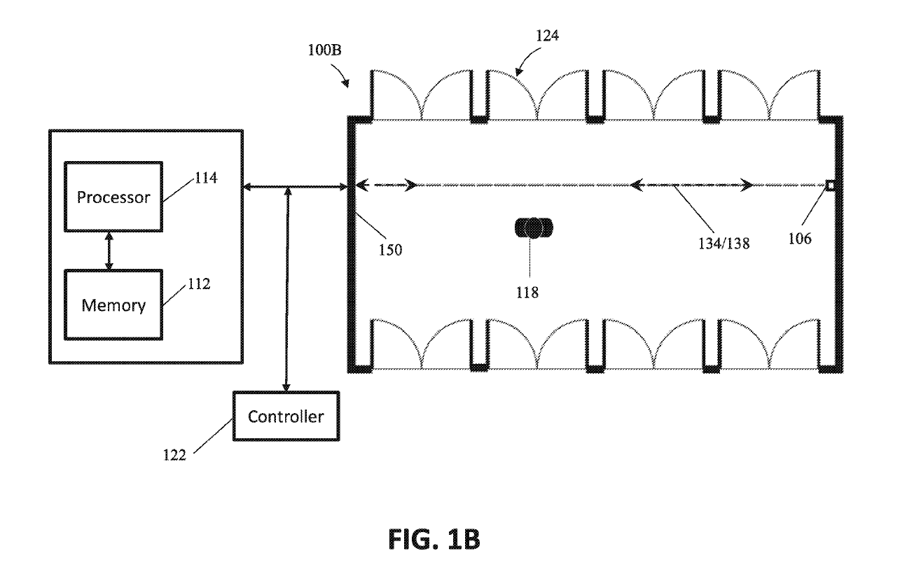

FIG. 1 depicts a system 100 for people and/or asset flow monitoring and/or management according to one embodiment of the present disclosure. In the depicted embodiment, system 100 comprises a plurality of transceivers 106 configured to transmit and/or receive a plurality of vertical (or in an angle less than 90 degrees to vertical) light beams 140. The plurality of light beams 150 may be reflected by a structure 150 (e.g., a floor, a glass, or other types of reflectors), and generate a plurality of reflected light beams 144, each may be received by one of the plurality of transceivers 106. Transceiver 106 may be an infrared light transmitter, a light emitting diode (LED), a laser, or a photoelectric sensor, or any other type of suitable transmitter. Transceiver 106 may be modulated at a specific frequency and/or frequency range, and configured to transmit and/or receive only light beams of certain frequency and/or frequency range. Light beams 140, 144 may be visible or invisible, may be infrared, may have a specified frequency or in a specified frequency range, etc.

In the depicted embodiment, system 100 may also comprise a memory 112. Memory 112 may be coupled to transceiver 106 and may be configured to store instructions to receive signals from transceiver 106, store the received signals, and/or process the signals. Signals received by memory 112 may comprise the existence, absence, or an interruption of light beam 140, 144. System 100 may further comprise a processor 114 coupled to memory 112 and configured to execute instructions stored in memory 112.

Processor 114 may be configured to execute instruction from memory 112 to determine whether an interruption of light beams 140 and/or 144 is caused by a target 118 (e.g., a person or object of a specified type(s)) passing through light beams 140/144, or caused by an objects other than a targeted object. Based on interruptions of light beams 140, 144 determined to be caused by a target 118 (e.g., a person or object), processor 114 may count the number of targets passing through light beams 140/144 during a period of a time. For example, processor 114 may count the number of people entering and/or exiting a building, a room, or a mall over (e.g., during an hour or other period of time). Based on the count of the number of people entering and/or exiting a building, processor 114 may also calculate the number of people inside a building or room at a given time. Based on a relative height of light beams 140, 144 (e.g., height of light beam relative to the floor below it), processor 114 may also determine the height of a person when the person passes through light beams 140/144 based on an interruption pattern of light beams by the person. Memory 112 and/or processor 114 may be located at the same place as transceiver 106, or at a place separate from transceiver 1056.

In some embodiments, system 100 may comprise a controller 122 coupled to transceiver 106. Controller 112 may be configured to detect an interruption of light beams 140/144. Controller 122 may also facilitate the transmission of signals from receiver to memory 112 and/or processor 114. Controller 122 may be housed with transceiver 106 or at a place separate from transceiver 106.

When multiple persons 118 pass through the light beams and interrupts one or more of light beams 140, the corresponding reflected light beam(s) 138 will be interrupted as well. Transceivers 106 then records the interruption in raw data and send the data to processor 114, which may determine whether each interruption is caused by a person or other objects. Based on determinations that light beams 134, 138 are interrupted by persons, processor 114 can also counts the number of persons entering/exiting an area of interest covered by the light beams.

One advantage of the vertical beams (or beams with an angle less than 90 degrees to vertical), when multiple persons pass through the light beams side by side, system 100 may be able to determine that multiple persons (rather than one person) pass through the light beams at the same time, and/or whether multiple persons moved sided by side, or one in front of another. These determinations may be based on, e.g., the number of beams that are simultaneously interrupted and the distance(s) between the interrupted beams. To this end, a guiding structure to guide target moving through the light beams sequentially may not be necessary in system 100 because the overhead light beam design may be designed to determine whether multiple persons pass through the light beams at the same time.

It should be noted that although FIG. 1 depicted more than two light beams, in some embodiments, system 100 may comprise only two light beams to perform any of the functions described above. In some embodiments, some transceivers 106 are mounted on the top (e.g., ceiling) and some are mounted on the bottom (e.g., floor). It should also be noted that in some embodiments, instead of having transceivers 106, system 100 may comprise multiple transmitters mounted on the top and each configured to transmit a light beam, and multiple receivers on the bottom and each configured to receive a light beam from one of the transmitters. In some other designs, all the transmitters may be mounted on the bottom and all receivers on the top. In yet other designs, a mixture of transmitters and receivers are mounted on the top or the bottom.

FIG. lA depicts a system 100A for people and/or asset flow monitoring and/or management according to one embodiment of the present disclosure. In the depicted embodiment, system 100A comprises a photoelectric transmitter 104 configured to transmit a light beam 130. Transmitter 104 may be an infrared light transmitter, a light emitting diode (LED), a laser, or a photoelectric sensor, or any other type of suitable transmitter. Light beam 130 may be visible or invisible. Light beam 130 may be infrared light, or light of a specified frequency or in a specified frequency range. System 100 may comprise a receiver 108 configured to receive light beam 130 from transmitter 104. Receiver 108 may be configured to receive only light beams of a specified frequency or frequency range from transmitter 104 and reject light beams of other frequencies. For example, receiver 108 may be modulated at a specific frequency and receives only light beams of matched frequency of transmitter 104.

In some embodiments, light beam 130 may be vertical or horizontal in direction, or in an angled direction. Transmitter 104 may be installed on a wall, a ceiling, a floor, a door frame, a window frame, or any other structure. Similarly, receiver 108 may be installed on a wall, a ceiling, a floor, a door frame, a window frame, or the like. Transmitter 104 and receiver 108 may be installed at an entrance, exit, elevator, stair well, escalator, or a specified point of a structure 124. Structure 124 may be a room, a building, a mall, a plaza, a parking lot, a control point, or any other specified area of interest.

In the depicted embodiment, system 100A may also comprise a memory 112.

Memory 112 may be coupled to receiver 108 and may be configured to store instructions to receive signals from receiver 108, store the received signals, and/or process the signals. Signals received by memory 112 may comprise the existence, absence, or an interruption of light beam 130. System 100 may further comprise a processor 114 coupled to memory 112 and configured to execute instructions stored in memory 112.

Processor 114 may be configured to execute instruction from memory 112 to determine whether an interruption of light beam 130 is caused by a target 118 (e.g., a person or object) passing through light beam 130, or caused by an objects other than a person. Based on interruptions of light beam 130 determined to be caused by a target 118 (e.g., a person or object), processor 114 may count the number of persons passing through light beam 130 during a period of a time. For example, processor 114 may count the number of people entering and/or exiting a building, a room, or a mall in the past hour. Based on the count of number of people entering and/or exiting a building, processor 114 may also calculate the number of people inside a building or room at a given time. Based on a relative height of light beam 130 (e.g., height of light beam 130 relative to the floor below it), processor 114 may also determine the height of person 118 when person 118 passes through light beam 130 based on an interruption pattern of light beam 130 by person 118. Memory 112 and/or processor 114 may be located at the same place as receiver 108, or at a place separate from receiver 108.

In some embodiments, system 100 may comprise a controller 122 coupled to receiver 108. Controller 112 may be configured to detect an interruption of light beam 130. Controller 122 may also facilitate the transmission of signals from receiver to memory 112 and/or processor 114. Controller 122 may be housed with receive 108 or at a place separate from receiver 108. System 100 may further comprise a guiding structure 128 configured to guide a target 118 (e.g., a person or object) moving through light beam 130. Guiding structure 128 may be configured to guide persons passing through light beam 130 sequentially such that when multiple persons walk together, light beam 130 will not be blocked by one person and never reach another person.

In some embodiments, transmitter 104 may be an ultrasonic sensor, or microwave sensor. Accordingly, signal 130 may be an ultrasonic signal or a microwave signal, and receiver 108 may be configured to receive signal 130 from transmitter 104.

FIG. 1B depicts a system 100B for people and/or asset flow monitoring and/or management according to one embodiment of the present disclosure. System 100B comprises a transceiver 106 configured to transmit and/or receive a light beam. In the depicted embodiment, transceiver 106 transmits a light beam 134, which is reflected by a structure 150, and the reflected light beam 138 is received by transceiver 106. Light beams 134 and 138 may have similar characteristics as the light beams described above, such as being visible, invisible, infrared, etc. System 100B may also comprise a memory 112, a processor 114, a controller 122, and/or a guiding structure 128, which have similar characteristics and configured to perform similar functions as described above in FIG. 1. For example, when a target 118 (e.g., a person or object) passes through the light beams and interrupts light beam 134, the reflected light beam 138 will be interrupted as well. Transceiver 106 then records the interruption in raw data and send the data to processor 114, which may determine whether the interruption is caused by a person or other objects. Based on determinations that light beams 134, 138 are interrupted by persons, processor 114 can also counts the number of persons entering/exiting an area of interest covered by the light beams. In the depicted embodiment, light beams 134, 138 are horizontal in direction. In other embodiments, light beams 134, 138 may be vertical, or at an arbitrary angle. Structure 150, which reflects light beams 134, 138 may be a wall, a floor, a window, or the like.

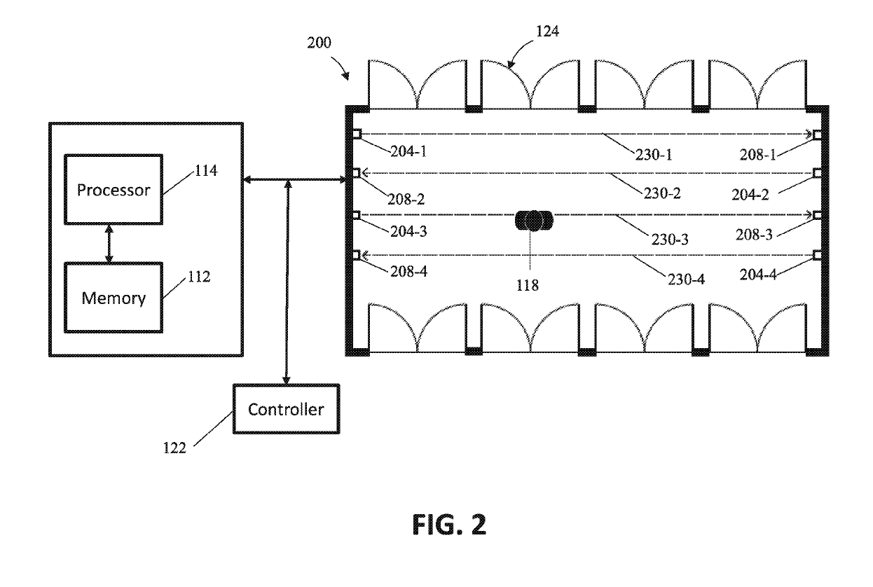

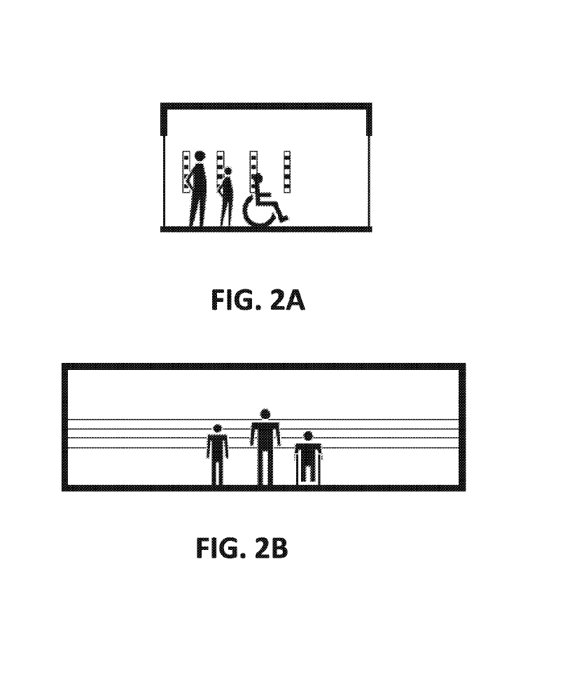

FIG. 2 depicts a system 200 for people and/or asset flow monitoring and/or management according to one embodiment of the present disclosure. In some embodiments, system 200 may comprise only two pairs of transmitters and receiver. In some embodiments, system 200 may comprise more than two pairs of transmitters and receivers.

System 200 may comprise a transmitter 204-1 configured to transmit light beam 230-1, and a receiver 208-1 configured to receive light beam 230-1. System 200 may further comprise a transmitter 204-2 configured to transmit a light beam 230-1, and a receiver 208-2 configured to receive light beam 230-2.

In some embodiments, light beams 230-1 and 230-2 may travel in the same direction. Alternatively, light beams 230-1 and 230-2 may travel in the opposite directions. Light beams 230-1 and 230-2 may be parallel to each other, or non-parallel with each other at an angle. In some embodiments, light beams 230-1 and 230-2 may cross at a certain point between the transmitters and receivers. Light beams 230-1 and 230-2 may have the same frequency or have different frequencies. The distance between light beams 230-1 and 230-2 may be designed such that when a target 118 (e.g., a person or object) passes through the light beams, person 118 only interrupts one of the two light beams at any given time. This can be achieved, for example, by making the distance between light beams 230-1 and 230-2 larger than a width between a typical adult person's front and back. This distance requirement allows a target (e.g., a person or object) passing through light beams 230-1 and 230-2 to interrupt the two light beams and different times, and thus based on the time difference, the person's moving direction can be determined. Light beams 230-1 and/or 230-2 may be infrared light and/or light generated by a LED sensor.

System 200 may also include memory 112 and/or processor 114 as described above and perform the functions as described above. Processor 114 may also be configured to execute instructions from memory 112 to determine whether an interruption of light beam 230-1 is caused by a target 118 (e.g., a person or object) passing through light beam 230-1, and determine whether an interruption of light beam 230-2 is caused by the same person 118 passing through light beam 230-2. Processor 114 may be further configured to, if it determines the same person 118 passes through light beams 230-1 and 230-2, the time and/or the order by which person 118 passes through light beams 230-1 and 230-2, respectively. Based on the respective time and/or the order by which person 118 passes through light beams 230-1 and 230-2, processor 114 may also determine a moving direction of person 118, based on the relative position of light beams 230-1 and 230-2. Based on the respective time when person 118 passes through light beams 230-1 and 230-2, processor 114 may also determine the duration of time by which person 118 stayed in the area between light beams 230-1 and 230-2.

Light beams 230-1 and 230-2 may be installed at the same relative height (e.g., height relative to the flow below the light beams), or at different relative heights. Based on the relative heights of light beams 230-1 and 230-2, and an interruption pattern of light beams 230-1 and 230-2 by person 118, processor 114 may determine the height of person 118 when and/or after person 118 passes through light beams 230-1 and 230-2.

Optionally, system 200 may also comprise one or more additional pairs of transmitters and receivers, such as transmitters 204-3, 204-4, and receivers 208-3, 208-4, where each transmitter-receiver pair is configured to transmit and receive a light beam, such as light beams 230-3, 230-4. The additional transmitters, receivers, and light beams may have similar functions and/or characteristics of those described above. The distances between the transmitters (or the receivers) may be uniform or non-uniform. System 200 may further comprise a guiding structure 128, as described above and perform functions as described above in connection with FIG. 1. Like system 100, system 200 may also be installed at a structure 124, which may be a building, a room, a parking lot, a specified area, or the like.

FIGS. 2A and 2B depict a side view and a front view, respectively, of a plurality of person passing through a light curtain formed by a plural of light beams between a plurality pair of photoelectric transmitters and receivers, as described above in connection of FIG. 2. As illustrated in FIG. 2A, three persons of different height pass through a plurality of light beams sequentially. The distance between the light beam may be designed such that each person interrupts at most one light beam at any given time. As illustrated in FIG. 2B, a plurality of light beams may be placed at different heights. This facilitates the system to determine the height of a person passing through the light beams based on an interruption pattern of the beams by the person.

In the depicted example in FIGS. 2A and 2B, one person on a wheel chair is passing through a light curtain formed by a plurality of light beams. Systems 100 and 200 may be configured to detect a person on a wheelchair passing through a light beam, as opposed to objects such as a cart. This can be achieved by analyzing, e.g., via processor 114 executing instructions from memory 112, an interruption pattern of an light beam.

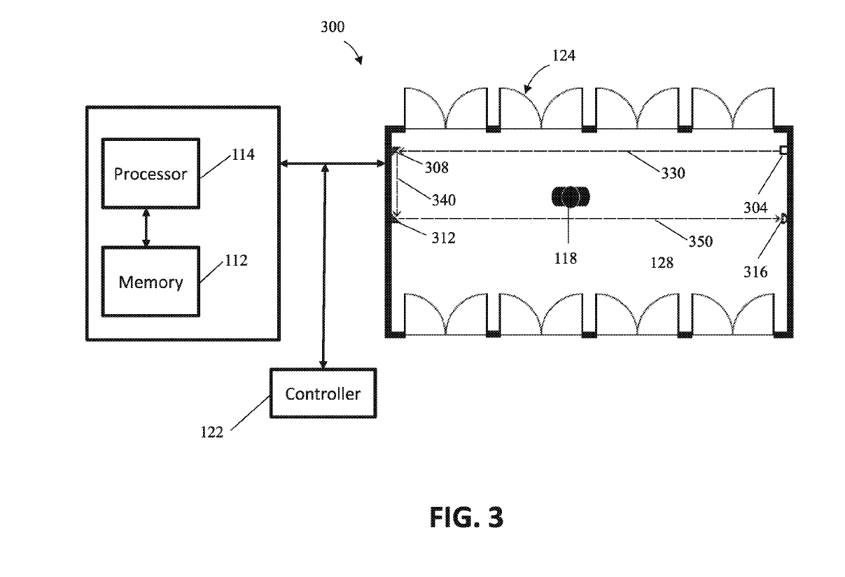

FIG. 3 depicts a system 300 for people and/or asset flow monitoring and/or management according to one embodiment of the present disclosure. In some embodiments, system 300 may include a transmitter 304. Transmitter 304 may be a photo electric transmitter, similar to transmitters described above, and configured to transmit light beam 330. System 300 may also comprise a receiver 308, configured to receive light beam 330. Receiver 308 may further function as a reflector, which reflects light beam 330 to a different direction and generates light beam 340. Light beam 340 may be further reflected by reflector 312 to a different direction and generate light beam 350. System 300 may comprise a receiver 316 configure to receive light beam 350.

In some embodiments, light beams 330 and 350 may be parallel. Alternatively, light beams 330 and 350 may be non-parallel but does not cross each other at a point between transmitter 304 and receiver 308. Light beams 330 and 350 may be visible or visible, and have a frequency and/or characteristics similar to light beams described above.

In some embodiments, a distance between light beams 330 and 350 may be designed such that when a target 118 (e.g., a person or object) passes through light beams 330 and 350 sequentially, person 118 only interrupts one of the light beams at any particular time.

System 300 may further comprise one or more of memory 112, processor 114, controller 112, guiding structure 128, which have characteristics as described above and function as described above. System 300 may be installed at a structure 124, which may be a building, a room, a parking lot, a specified area, or the like.

Like systems 100 and 200, system 300 may be configured to perform various functions, such as detecting interruptions of a light beam, determining whether the interruption is caused by a person passing through a light beam, determining a moving direction of a person passing through light beams, determining the height of a person, and/or the duration of time a person spent in an area between the light beams. These functions are performed by system 300 in a similar way as described above.

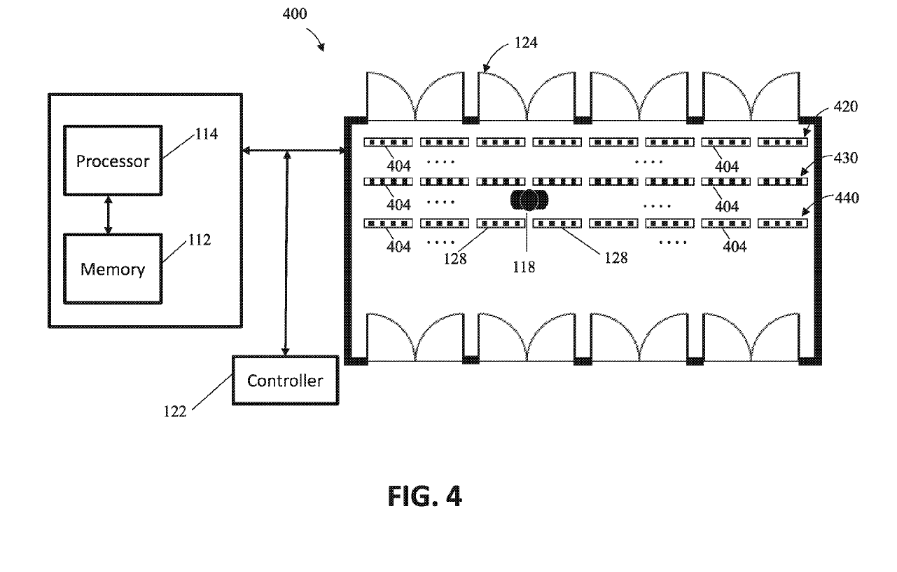

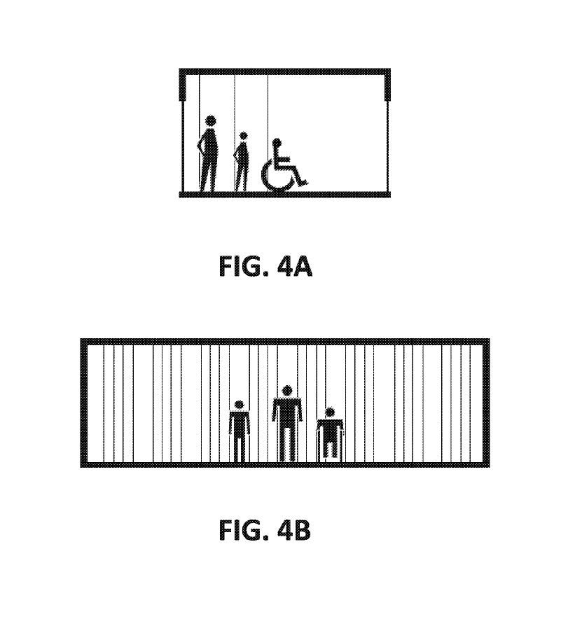

FIG. 4 depicts a top/side view of a system 400 for people and/or asset flow monitoring and/or management according to one embodiment of the present disclosure. In the depicted embodiment, system 400 comprise a plurality of transmitters 404. Each transmitter 404 may be configured to transmit a light beam at a specified frequency. Alternatively, a transmitter 404 may be configured to transmit a ultrasonic signal, a microwave signal, or other types of signals. The plurality of transmitters 404 may transmit the same type of signals (e.g., all light beams), or a mix of different types of signals (e.g., some light beams and some ultrasonic signals). When the plurality of transmitters 404 are configured to transmit light beams, the light beams may have the same frequency or have different frequencies, the light beams may be infrared, may be visible or invisible, and may have characteristics similar to light beams described above.

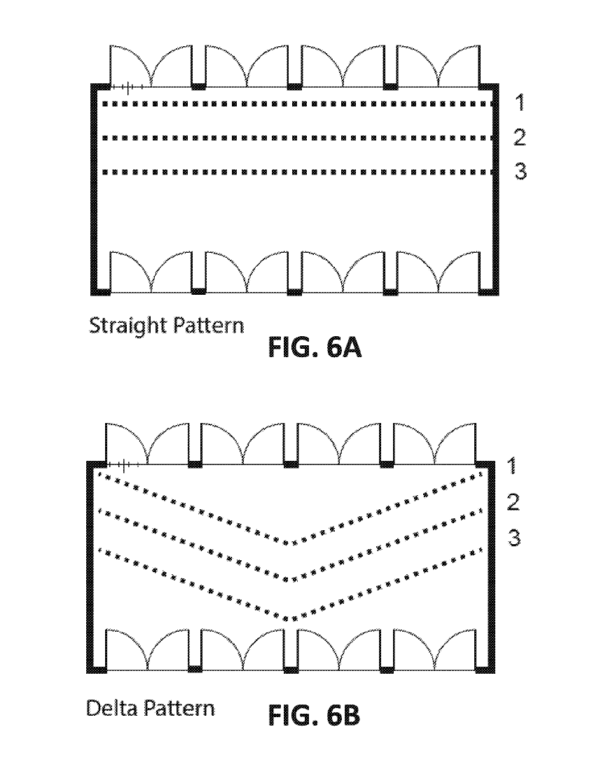

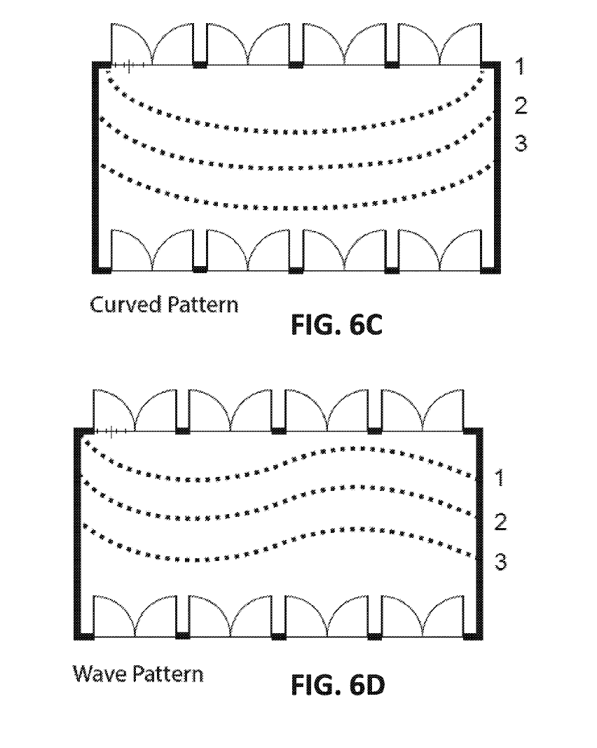

The plurality of transmitters 404 may be grouped into one or more arrays, where each array has a plurality of transmitters. In the depicted embodiment, a plurality of transmitters 404 are grouped into three arrays of transmitters 420, 430, 440, where each array of transmitters is parallel to anther array of transmitters. Multiple arrays of transmitters 404 may he aligned into various shapes, as illustrated in FIGS. 6A-6D. For example, arrays of transmitters may be aligned in straight lights as shown in FIG. 6A, bended lines forming a delta pattern as shown in FIG. 6B, curved lines as shown in FIG. 6C, and wave-shaped lines as shown in FIG. 6D. Although in the illustrated embodiments in FIGS. 6A-6C the transmitter arrays are parallel to each other, the arrays may be non-parallel to each other in some embodiments.

System 400 may also comprise a plurality of receivers (not shown in FIG. 4), each configured to receive a signal (light beam, ultrasonic, microwave, etc.) from one of the plurality of transmitters 404. System 400 may further comprise a processor 114, memory 112, a controller 122, and/or a guiding structure 128, which are configured similarly as described above, and perform functions similar to those described above. System 400 may be installed at a structure 124, which may be a building, a room, a parking lot, a specified area, or the like.

In some embodiments, arrays of units 420, 430, 440 may comprise a mixture of transmitters and receivers. For example, in one setting, each array 420, 430. and/or 440 may comprise some transmitters and some receivers. In another setting, array 420 comprises only transmitters and array 430 comprises only receivers. These settings may also be applied to the patterns depicted in FIGS. 6A-6D. One of ordinary skill in the art may recognize any other arrangement of the transmitters/receivers or the combinations thereof.

In some embodiments, a distance between two adjacent units (transmitter and/or receiver) in an array 420, 430, or 440 may be designed such that when a target 118 (e.g., a person or object) passes through, person 118 will interrupt at least one light beam transmitted/received by transmitters/receivers of the array. For example, in a vertical setting where light beams transmitted/received array 420 are vertical in direction, the distance between two adjacent units in array 420 may be designed to be less than a typical adult person's shoulder width. Thus, when a person passes through array 420, the person will interrupts at least one light beam from array 420 even if the person attempts to pass array 420 through a gap between two adjacent light beams from two adjacent units of array 420. Similarly, a distance between two adjacent arrays (e.g., arrays 420 and 430) may be designed such that when a person passes through the two arrays, the person interrupts only light beams from one array but not light beams from another array. In some embodiments, distances between two adjacent units in a array 420, 430, 440 may be uniform (distances are equal) or non-uniform (distances are not equal). Distances between two adjacent arrays 420, 430, 440 may be uniform or non-uniform.

In some embodiments, units 404 of system 400 may be transceivers (instead of transmitters), each configured to transmit and/or receive a light beam. In these embodiments, no separate receivers are required for system 400. Instead, each light beam transmitted by transceivers 404 may be reflected by a structure (e.g., a floor, a wall, etc.), and each reflected light beam may be received by one of the transceivers 404 (a reflected light beam may be received by the same transceiver which transmitted the light beam, or by a different transceiver). System 400 with transceivers 404 may be configured to detect, count, and track people flow in similar ways as described above in connection with FIG. 1B and/or FIG. 4.

Similarly, any system described above or below where the system uses a pair of transmitter and receiver may be replaces by a single transceiver, which may function in a ways similar to transceivers described in FIG. 1B and/or FIG. 4 above.

FIGS. 4A and 4B depict a side view and a front view, respectively, of a plurality of person passing through a light curtain formed by a plural of light beams between a plurality pair of photoelectric transmitters and receivers, as described above in connection of FIG. 4. As illustrated in FIG. 2A, three persons of different height pass through a plurality of light beams sequentially. In the depicted embodiment, the plurality of light beams are vertical in direction. The distance between the light beams may be designed such that each person interrupts at most one light beam at any given time when passing through the plurality of light beams. As illustrated in FIG. 4B, a plurality of light beams may be placed side by side. Distances between two adjacent light beams may be designed such that when a person attempts to pass through the light beams, the person will interrupts at least one of the light beams, even if the person attempts to pass through via a gap between two light beams.

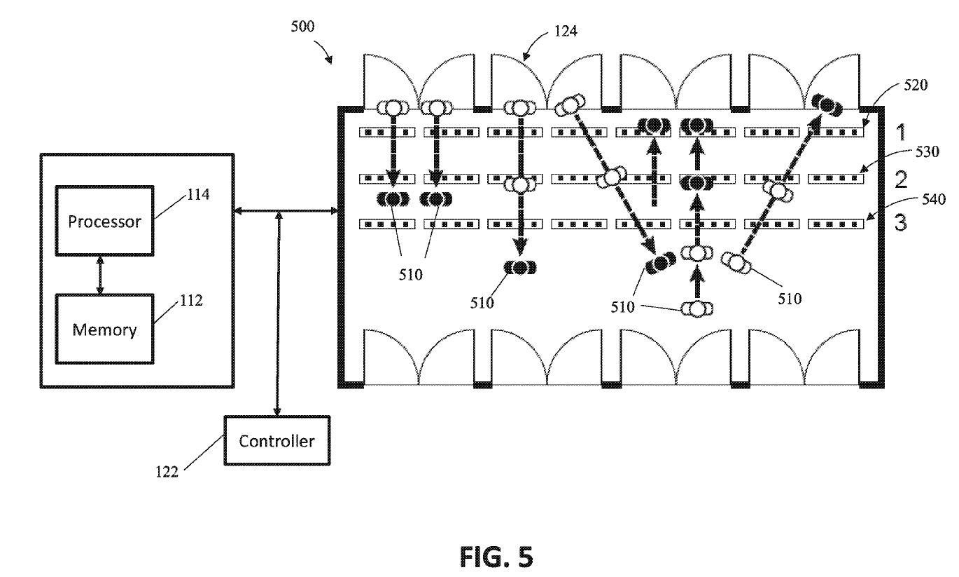

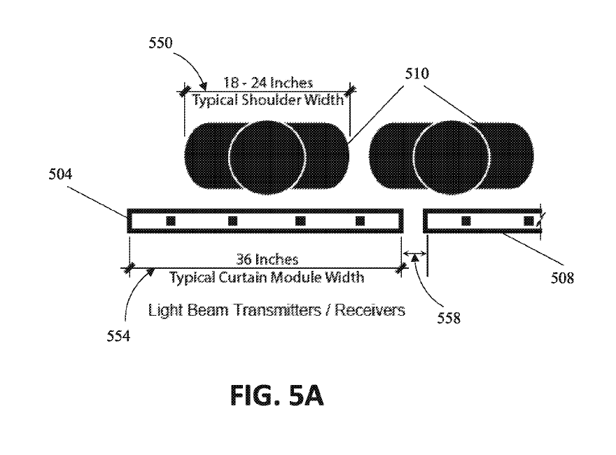

FIG. 5 depicts a top/side view of a system 500 for people and/or asset flow monitoring and/or management showing multiple people passing through a light curtain. As shown in FIG. 5, system 500 comprises multiple arrays 520, 530, 540 of transmitters/receivers each configured to transmit/receive a light beam. Arrays 520, 530, 540 may each only comprise a plurality of transmitters only, receivers only, or a mix of transmitters and receivers. Each transmitter is configured to transmit a light beam, and each receiver is configured to receive a light beam from one of the transmitter. The alignments, compositions, and positioning of arrays 520, 530, 540 may be similar to the arrays described above in connection with FIGS. 4 and 6A-6D.

In the example shown in FIG. 5, multiple person 510 passes through one or more light beams from the arrays 520, 530, 540 of transmitters/receivers. At any particular point of time, different person may travel in different direction and interrupt different light beams. System 500 is configured to determine whether an interruption of a light beam is caused by a person passing through the light beam, count the number of persons passing through one or more light beams during a period of time, determine a direction and/or speed of travel of a person, determine the height of a person, and the such, in similar ways described above.

FIG. 5A depicts a design size and arrangement of two adjacent units (transmitter(s) or receiver(s)) in an array of transmitters/receivers in FIG. 5. Two adjacent units 504 and 508 depicted in FIG. 5A may both be a transmitter, both be a receiver, or one transmitter and one receiver. In some other embodiments, each of the two adjacent units 504 and 508 depicted in FIG. 5A may have, aligned side by side, multiple transmitters, multiple receivers, or a mixture of transmitters and receivers. In the depicted embodiment, length 554 of unit 504 may be designed to be wider than a typical shoulder width 550 of an adult person 510. Length of unit 508 may be designed similarly. The lengths of units 504 and 508 also reflect the width of a light beam or multiple light beams transmitted/received by the units. A distance 558 between units 504 and 508 may be designed to be larger than a typical shoulder width 550 of an adult person 510. With this design, when a person 510 passes through light beams transmitted from/received by units (e.g., 504 and 508) from an array of units (e.g., an array shown in FIG. 5), the person will interrupt at least one light beam from a unit. In the case each unit 504, 508 comprises multiple transmitters/receivers aligned side by side, a the person may interrupts multiple light beams when passing through an area covered by the units.

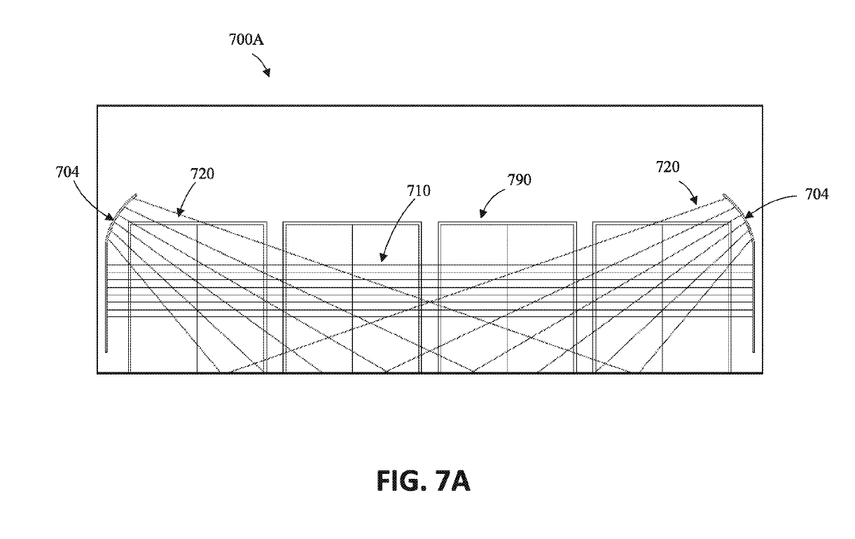

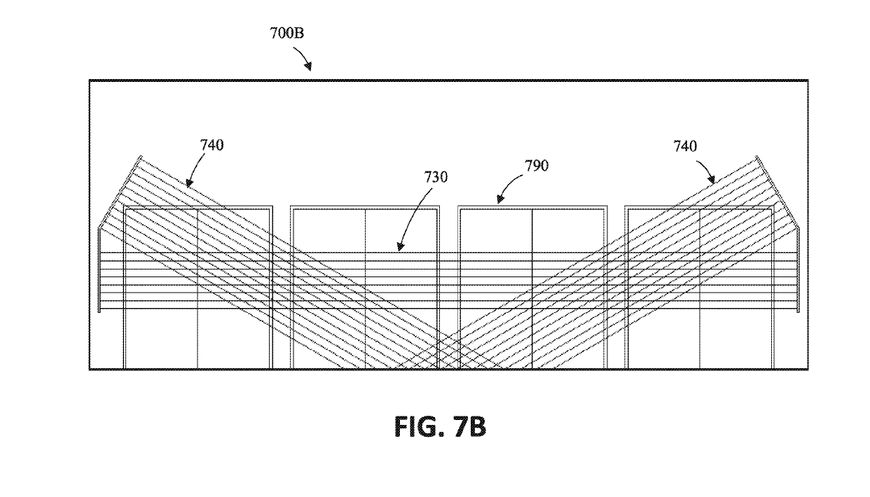

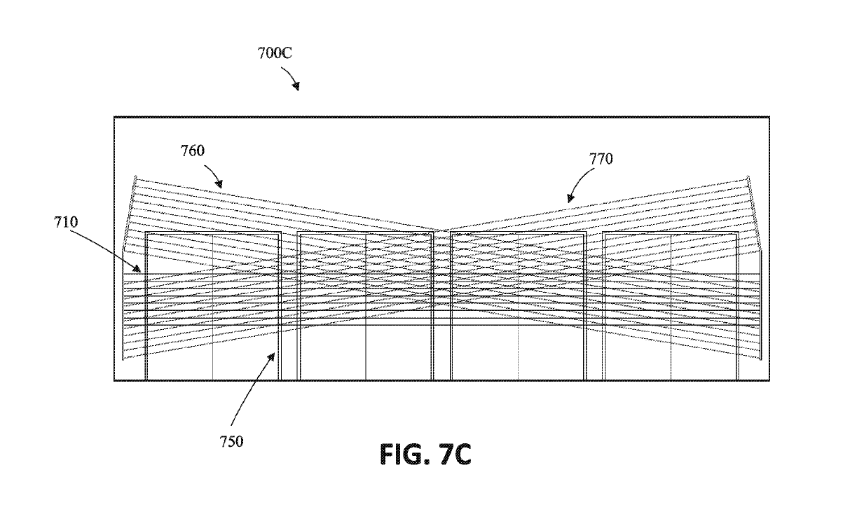

FIGS. 7A-7C depict various additional design patterns of light curtains according to the present disclosure. The design patterns of light curtains depicted in FIGS. 7A-7C can be used in any of the systems as described above for monitoring people flow such as systems 100-500, with the assistance of memory 112, a processor 114, and/or a controller 122. For example, FIG. 7A comprises a plurality of transmitters/receivers 704 to transmit/receive a first set 710 of light beams, which comprises a plurality light beams. The transmitters of system 700 may also be configured to transmit a second set of light beams 720. The directions of light beams 720 may be changed by a plurality of reflectors and are then received by a plurality of receivers. In some embodiments, individual light beams in the first set 710 and/or second set 720 of light beams may be visible or invisible, may be infrared light beams, may have the same frequency or different frequencies, and/or may travel in the same direction or different directions. In the depicted embodiment, individual light beams from the first set 710 of light beams are parallel to each other and are horizontal in direction, and individual light beams from the second set 720 of light beams are non-parallel to each other and are in an angled direction. In some other embodiments, individual light beams from the first set 710 and second set 720 of light beams may all be non-parallel to one or more other light beams, some of the light beams may be horizontal, some light beams may be vertical, and some light beams may be in an angled direction (neither horizontal nor vertical). The first set 710 of light beams may be located at a specified distance away from the second set 720 of light beams so that a person can pass through the first set 710 and second set 720 of light beams sequentially. The first set 710 and second set 720 of light beams may be located at one or more entrance/exit point 790 of a room, building, mall, plaza, parking lot, or any other specified area.

FIG. 7B illustrates another design pattern of light curtains for monitoring people flow. In the depicted embodiments, a first set 730 of light beams have individual light beams that are parallel to each other and are horizontal in direction, a second set 740 of light beams have individual light beams that are parallel to each other and are in an angled direction (neither horizontal nor vertical). Similar to the design pattern in FIG. 7A, set 730 of light beams may be located at a specified distance away from the set 740 of light beams so that a person can pass through the set 730 and set 740 of light beams sequentially. The set 730 and set 740 of light beams may be located at one or more entrance/exit point 790 of a room, building, mall, plaza, parking lot, or any other specified area.

FIG. 7C illustrates another design pattern of light curtains for monitoring people flow, which has three sets 750, 760, and 770 of light beams, each set with a plurality of individual light beams. In the depicted embodiments, set 750 has individual light beams that are horizontal, and sets 760 and 770 have individual light beams that are in an angled direction. In some embodiments, an individual beam from any set may be in an arbitrary direction. Light beam sets 750, 760, and 770 may be located at a specified distance away from each other so that a person can pass through the sets of light beams sequentially.

The design patterns of light curtain illustrated in FIGS. 7A-7C may be used in connection with a processor, memory, and or a controller such as those described in systems 100-500, and are configured to perform similar functions of those systems as described above, such as determining whether an interruption of a light beam is caused by a person, counting the number of persons passing through light beams in a certain direction in during a period of time, determining the travel direction, travel speed, and/or height of a person, and/or determining the number of persons in a specified area (such as a room, a building, a plaza, etc.) at a particular time.

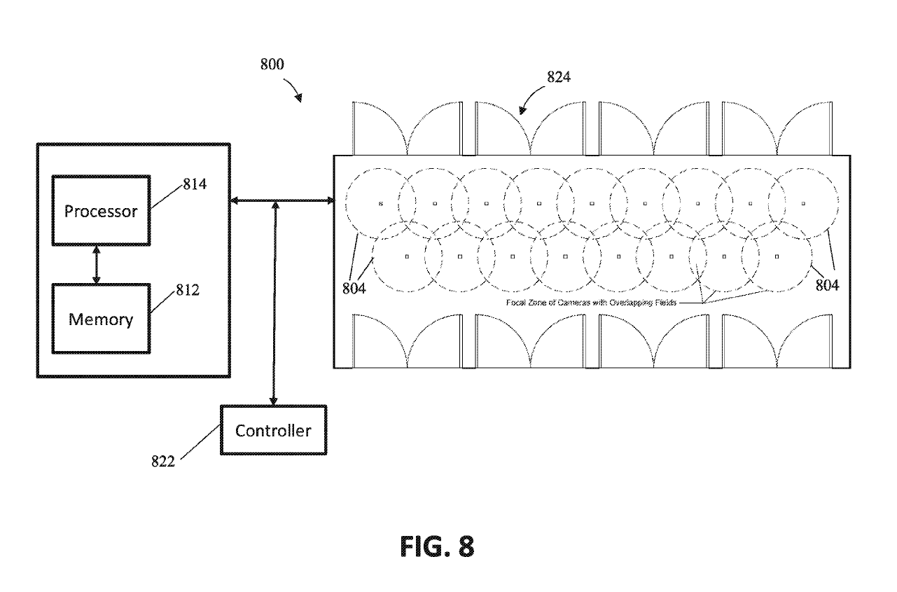

FIG. 8 depicts a system 800 for people and/or asset flow monitoring and/or management according to one embodiment of the present disclosure. In the depicted embodiment, system 800 comprises a plurality of cameras 804, each configured to capture photos of a certain area. Each camera 804 may be configured to automatically focus on objects (auto-focus), such as a person, in the view of the camera. The plurality of cameras 804 may be located side by side such that the focal zone of one camera overlaps with the focal zone of another camera. With such focal zone overlapping, any part of an area of interest may be covered by at least on camera, so that a person passing through the area could be captured by at least on camera when the person is at any part of the area of interest. Cameras 804 may be installed at an entrance/exit of a structure 824, which may be a room, a building, a plaza, a parking lot, etc. Cameras 804 may be installed on a wall, a ceiling, a door frame, a window frame, and/or on a floor, or the like.

System 800 may further comprise memory 812 configured to receive and/or store images captured by cameras 804. Memory 812 may also be configured to store one or more instructions to analyze images captured by cameras 804. System 800 may also comprise a processor 814. Processor 814 may be configured to execute instruction form memory 812 to analyze contents of images and to determine whether an object in an image captured by cameras 804 is a person, and/or count the number of persons passing an area of interest during a period of a time based on such determination. For example, processor 114 may count the number of people entering and/or exiting a building, a room, or a mall in the past hour. Based on the count of number of people entering and/or exiting an area of interest (such as a room, a building, a plaza, a parking lot, etc.), processor 814 may also calculate the number of people inside the area at a given time, the number of people entering/exit the area during a time period. System 800 may also comprise a controller 822 configured to facilitate the transmission of image signals or control signals between cameras 804, memory 812, and/or processor 814.

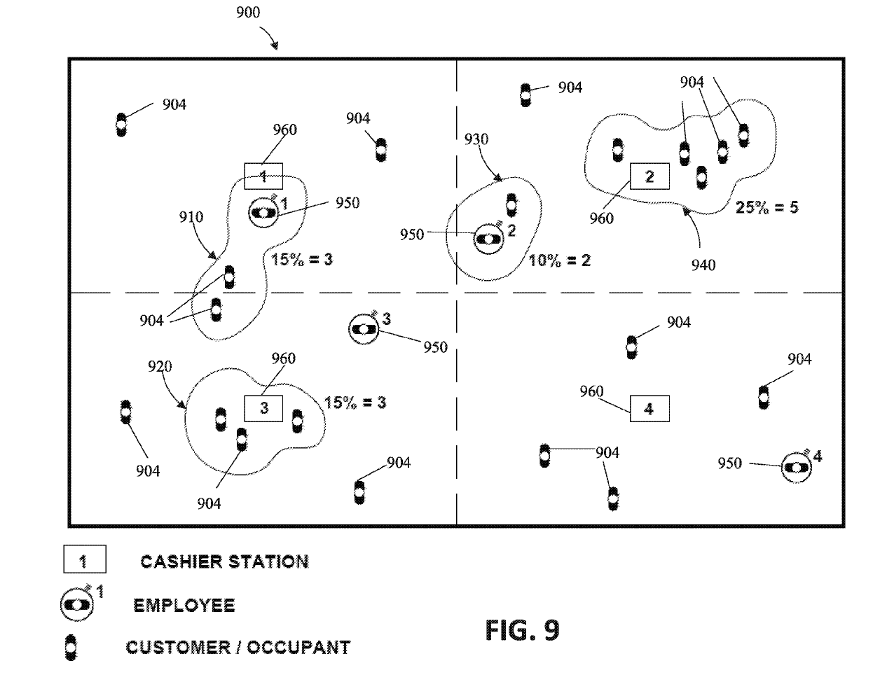

FIG. 9 depicts a system 900 for monitoring people flow in an area of interest. System 900 may comprise one or more sensors configured to receive signals from a device (such as a mobile phone, a Bluetooth device, a tablet, a health monitoring device, a RFID device, or the like) attached to a customer 904, and/or an employee 950. System 900 may further comprise memory (not shown) configured to receive and/or store signals, and to store one or more instructions to analyze received signals. System 900 may also comprise a processor (not shown) configured to executed instruction to analyze signals received so as to determine locations, traveling speed, and/or traveling direction of one or more customers 904 and/or employees 950 in an area of interest. System 900 may also be configured to count the number of customers 904 in an area of interest, or in any zone 910, 920, 930, 940, or around a station 960 in the area of interest. In some embodiments, system 900 may be configured to send signals to one or more employees 950 and direct employees 950 to move to a certain location to attend customers in an area, based on the density of customers in an area.

Signals transmitted between sensors of system 900 and devices attached to a customer 904 and/or an employee 950 may be WiFi signals, LiFi signals, Bluetooth (such as Bluctooth low energy) signals, light beams, or the like, or a mixture of these types of signals. Suitable communications protocols include, but are not limited to, Wi-Fi, infrared, ZigBee, Bluetooth, constrained application protocol (CoAP), satellite protocols, local area network (LAN), wide area network (WAN), radio, cellular, communications protocols that are later developed, and/or the like, and such communications protocols, where appropriate, may operate at any suitable frequency (e.g., 900 megahertz (MHz), 2.4 gigahertz (GHz), 5.8 GHz, and/or the like). Such communications can be secured (e.g., encrypted, for example, by a processor) to prevent unauthorized communications.

Data collected by system 900 can provide emergency responders with immediate occupant locations and/or counts inside a building, and provide details such as location, floor, room or other spatial configurations. When the data is shared with smart light or Internet of things (IoT) sensors, system 900 can yield more specific location data. By example and not limitation, if a gunshot or blast is detected by integrated systems with acoustic capabilities (such as Intellilum systems) or by one or more of many other sensing capabilities included, the location of the noise (gun shot or blast, etc.) can be identified immediately and designated on a floor plan or floor diagram. For example, these data correlated with the sensors detecting the movement of people rushing away from a shooter can provide emergency responders with the location of shooters, real-time counts of people in a facility even as people are rushing out of the facility the counts can be detected in real-time and updated real-time. Other correlated data can be cross-referenced and overlaid with the counts and locations of people.

As another example, if a retailer compares data from two identical stores in different locations, where both store have $10,000 in revenue and both stores have 150 transactions, they can surmise from that data an average sale of $66.67 per store or identical performance. However, if one of the systems described above counts people in the stores during these transaction periods and one store had 500 people and the other had 300 people—now the conversion of customer to sales is 500 customer to 150 sales which equals a 30% conversion rate versus 300 customers with 150 sales or a 50% conversion rate. Then, one may conclude that the performance of one store is notably different than the other; and other analytics can be provide as well that make the sales data far more meaningful to converting more customers to higher sales levels.

In some embodiments, system 900 can track identification badges by location such as by Bluetooth, RFID or other sensors that are attached to people or objects that have permitted access. This can narrow the search by elimination of parties that are in the facility or space and point out the probable location or offending parties. Occupants can locate themselves; they can locate offenders and others through a variety of means including the use of integrated mobile applications. These applications can provide panic buttons for teachers or other users or other designations for immediate danger, assistance needed, locations of injured, killed or aggressor locations and more. Even dragging icons onto floor plans or floor diagrams for real-time location designations that can be date and time stamped can aid emergency responders.

For revenue generating capabilities and analytic data for businesses, retailers and other building owners and manager can determine how many occupants are in a store or space at any given time. These data provide retailers with the following advantages once the total customer counts by floor, area, building or other designations can be defined in real-time and/or across designated time slots.

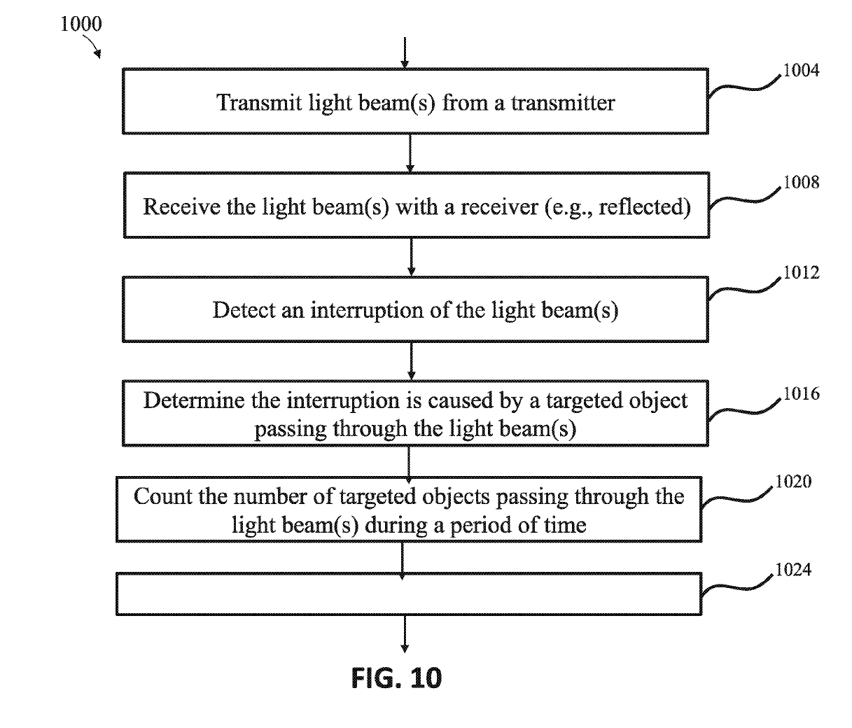

To illustrate, and referring to FIG. 10, depicted is a flow diagram of one embodiment of a method 1000 for monitoring people flow. Method 1000 may be implemented in connection with components of system 100 to monitory people flow in an area of interest. In the depicted embodiment, method 1000 comprises step 1004, where a light beam (or multiple light beams) is transmitted at a photoelectric transmitter. The light beam may be visible or invisible, may be an infrared light beam, a light beam generated by an LED, or a light beam of any frequency. The light beam may be horizontal, vertical, or in an angled direction (neither horizontal nor vertical, in an arbitrary angle). At step 1008, the light beam is received at a receiver. The receiver may be housed together with the transmitter or separate from the transmitter. When the receiver is housed together with the transmitter, the light beam(s) may be reflected back by a targeted object, a floor, or a reflector, and received by the receiver. The receiver may be modulated at a specific frequency and receives only light beams of matched frequency of the transmitter.

At step 1012, method 1000 detects an interruption of the light beam. The interruption may be detected by a controller coupled to a receiver that receives the light beam. Alternatively, raw data of receive light beam is sent to a processor, which processes the raw data and determines whether there is an interruption of the light beam. The raw data may be stored in a memory unit which can be accessed by the processor. Step 1016 determines whether an interruption of the light beam is caused by a targeted object (e.g., a person or object) or other types of object passing through the light beam. The determination may be made by a processor, which is configured to execute a plurality of instructions to analyze the raw data, and the instructions may be stored in a memory unit accessible by the processor. Based on determinations that an interruption is caused by a targeted object passing through the light beam(s), step 1020 counts the number of persons passing through the light beam during a period of time. In some embodiments, step 1020 only counts the number of persons passing through the light beam in a certain direction; for example, step 1020 may count the number of targeted objects (e.g., person or objects of a specified type) entering a building, the number of people exiting a building during a period of time.

In some embodiments, method 1000 may comprise additional steps 1024, such as guiding a person to pass through the light beam by a guiding structure such that when multiple persons pass through the light beam, the light will not be blocked by one person and never reach another person. Additional steps 1024 may also determine the height of a person passing through the light beam, e.g., based on a relative height of the light beam and an interruption pattern, and/or determine a travel direction of a person interrupting the light beam, e.g., based on an interruption pattern of the light beam.

All or some of the steps in method 1000 may be performed with the assistance of a processor, such as those described above in connection with systems 100-500, executing instructions stored in a memory.

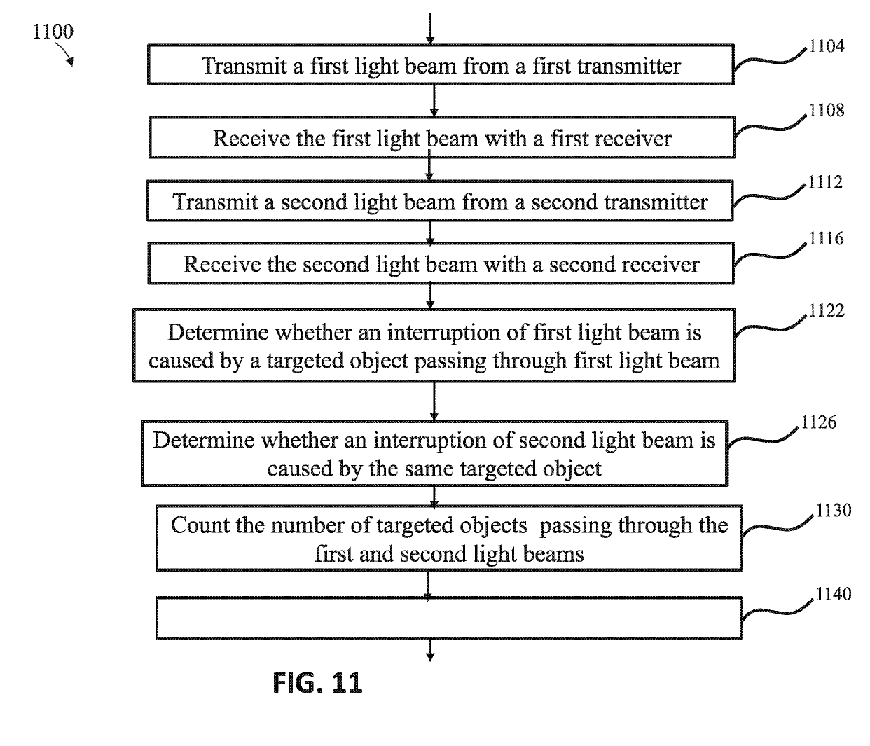

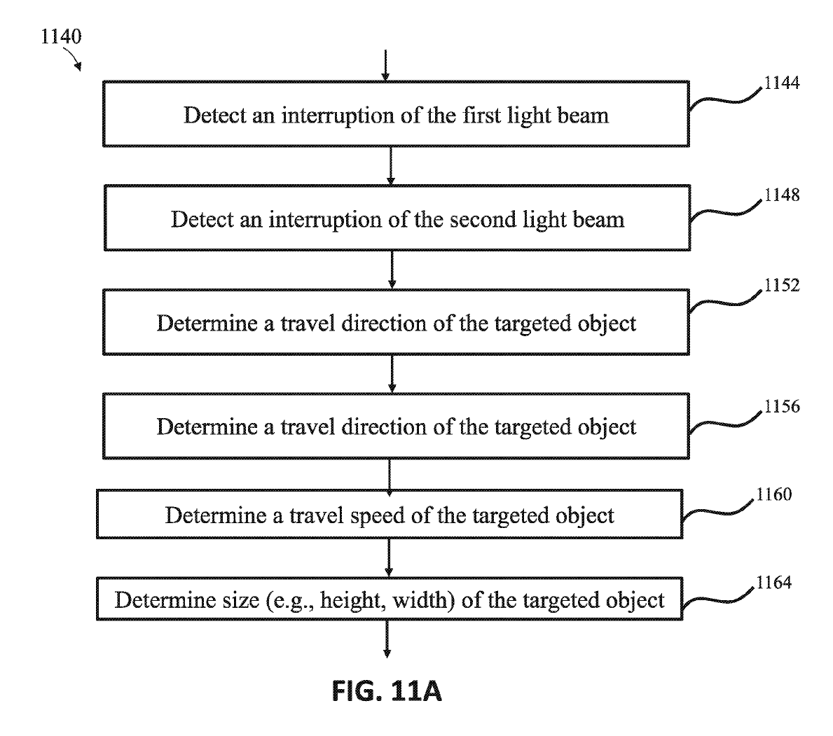

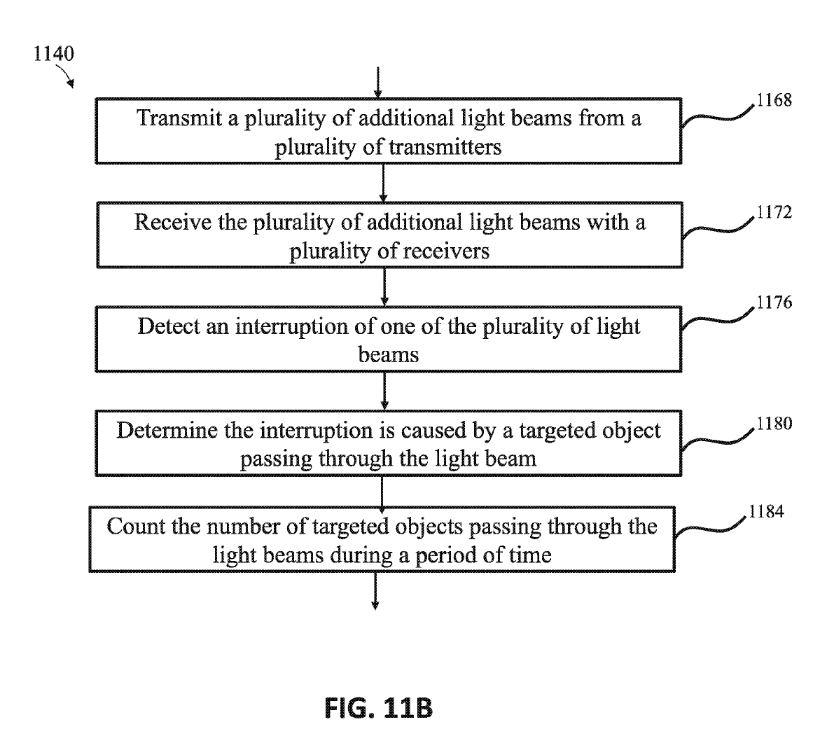

FIG. 11 depicts a flow diagram of one embodiment of a method 1100 for monitoring people flow. Method 1100 may be implemented in connection with systems 100-500, and/or with additional light curtain patterns described in FIGS. 6A-6D and 7A-7C to monitor people flow in an area of interest. In the depicted embodiment, method 110 comprises transmitting, at step 1104, a first light beam at a first transmitter, which may be received by a first receiver at step 1108. At step 1112, a second light beam is transmitted at a second transmitter, or alternatively, step 1112 changes the direction of the first light beam, e.g., by a floor, a targeted object, or one or more reflectors, to generate the second light beam. The second light beam is received at a second receiver at step 1116. The first light beam and second light beam may be visible or invisible, may be infrared light beams, may be generated by LEDs, and/or have other characteristics of light beams described above in connection of systems 100-500. The first light beam and second light beam may be parallel to each other or non-parallel to each other; may be vertical, horizontal, or in an angled direction; may travel in the same direction or the opposition direction; may be at the same height or different heights; may be positioned with a distance such that a person passing through the light beams may interrupt only one light beam at a time.

At step 1122, method 1100 determines whether an interruption of the first light beam is caused by a targeted object (e.g., a person or object of specified type) or other types of objects passing through the light beam. This determination can he performed, e.g., by a processor executing instructions to analyze an interruption pattern of the first light beam. Step 1126 determines whether an interruption of the second light beam is caused the same targeted object who interrupted the first light beam. Based on the determinations in steps 1122 and 1126, step 130 counts the number of targeted objects passing through the first and second light beams. For example, if step 1126 determines that the same targeted objects passes through the first and second light beams, the count is increased by one; but if the step 1126 determines that a different targeted object passes through the second light beam the count is increased by two. On the other hand, if steps 1122 and 1226 both determine that a non-targeted object passes through the light beams, the count is not increased. In some embodiments, based on the determination at step 1126, In some embodiments, method 1100 may comprise additional steps such as determining a time when a targeted object passes through a light beam, the size of the target object (e.g., width, height, etc.), and/or a traveling speed of the targeted object.

Method 1100 may comprise additional steps 1140, which are illustrated in FIGS. 11A-11B. For example, as depicted in FIG. 11A, steps 1144 and 1148 detect an interruption of the first light beam and the second light beam, respectively. The detection of an interruption of light beams may be performed by a controller coupled to a receiver of the light beams, and/or by a processor analyzing data received by receiver of the light beams. Method 1100 may further carry out various functions, such as determining, at step 1152, a travel direction of the targeted object based on an order the targeted object interrupted the first light beam and the second light beam, and the relative position of the first light beam and the second light beam; determining, at step 1156, a travel direction of a targeted object passing through the light beams, based on the time/order of the targeted object interrupting the light beams; determining, at step 1160, a travel speed of a targeted object passing through the light beams based on the respective time the targeted object passes through the first and second light beam; and/or determining, at step 1164, the size (e.g., a height, width, etc.) of a targeted object passing through the light beams, based on the relative height of the light beams and an interruption pattern of the light beams.

FIG. 11B illustrates some additional steps that may be included in method 1100. For example, at step 1168, a plurality of additional light beams may be transmitted at a plurality of transmitter, and the plurality of additional light beams may be received, at step 1172, at a plurality of receivers. Step 1176 detects an interruption of one of the plurality of light beams, step 1180 determines whether the interruption is caused by a targeted object (e.g., a person or object of a specified type) passing through the light beam, and step 1184 counts the number of targeted objects passing through the light beams in a direction during a period of time. The plurality of light beams may be positioned in any pattern, such as the patterns described in FIGS. 6A-6D and 7A-7C. The plurality of light beams may be separated into multiple sets or groups, where light beams from each set/group may have different directions from light beams from another set, such as those described in FIGS. 7A-7C.

All or some of the steps in method 1100 may be performed with the assistance of a processor, such as those described above in connection with systems 100-500, executing instructions stored in a memory.

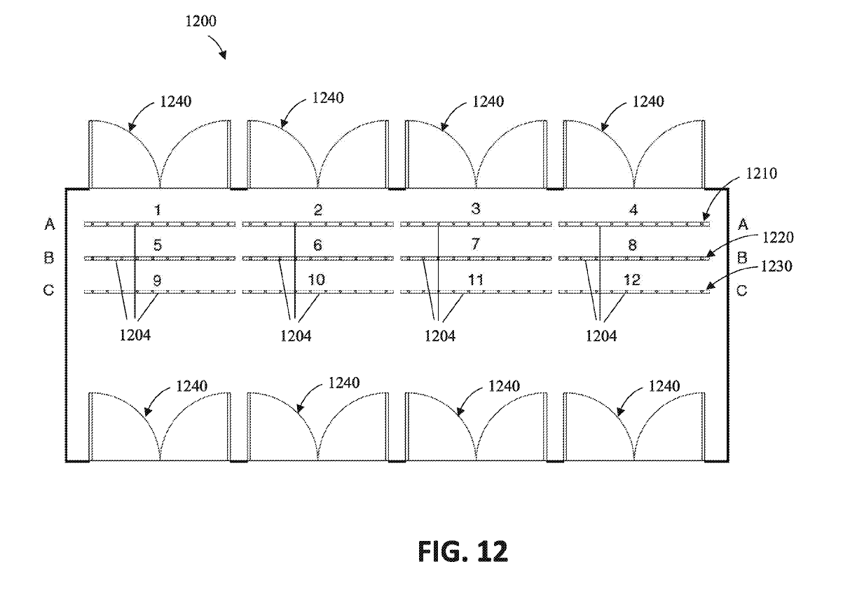

FIG. 12 depicts a system 1200 for people and/or asset flow monitoring and/or management using multiple light beams. In the depicted embodiment, system 1200 comprise three groups 1210, 1220, 1230 (Rows A, B, and C, respectively) of transmitters/receivers 1204, where each transmitter/receiver 1204 is configured to transmit/receive a light beam of a specific frequency (e.g., an infrared light beam). Each group 1210, 1220, or 1230 of transmitters/receivers are divided into four segments (numbered from 1-12, with segments 1-4 in group 1210, segments 5-8 in group 1220, and segments 9-12 in group 1230), each segment comprises multiple transmitters, receivers, or a combination of transmitters and receivers. The groups 1210, 1220, 1230 of transmitters/receivers may be configured to monitor people flow passing through entrance/exit points 1240, in connection with a memory unit, a processor, and/or a controller as described above.

System 1200 may be configured to detect persons passing light beams transmitted/received by groups the 1210, 1220, 1230 of transmitters/receivers in ways such as described above in connection of systems and methods. For example, each segment 1-12 may have transmitters/receivers to transmit/generate 10 light beams: light beams 1 through 10 in segment 1, light beams 11 through 20 in segment 2, light beams 21 through 30 in segment 3, and so on. If the beams are designed to be approximately 8-inches apart, by way of example and not limitation, at least two to three beams will he interrupted when a person of typical shoulder width of 18 to 24 inches walks below the beams. If two or three adjacent beams are interrupted at given time, system 1200 can determine that one person is passing through the light beams. If five or more adjacent light beams are interrupted at a given time, then system 1200 may determine that two person are passing through the light beams, and so on. If the same person(s) passes through multiple groups of beams from groups the 1210, 1220, 1230, the process can be repeated for one or more times to achieve better accuracy.

By determining an order and/or time a person interrupts light beams in different segments and/or groups, system 1200 can determine the person's direction of travel, speed, height, or other characteristics. For example, the distances between two adjacent transmitter/receiver, two adjacent segments, and two adjacent groups may be designed and input to the system. System 1200 then can calculate a travel speed of a person using the respective time the person interrupts multiple light beams and distances between the light beams. A travel direction of a person can be determined similarly.

System 1200 may also determine whether multiple persons pass through the light beams at the same time. For example, if two persons follow behind each other passing through the light beams, after the first person interrupts a light beam, the light beam will re-connect briefly in the gap between the two persons. The quick repeated interruptions will define a second person moving in the same direction as the first person and close behind.

Likewise, if beams 3, 4 and 5 in Row A are interrupted in close timing to beams 7, 8 and 9 in Row A, the system can determine that two people are walking along side each other. If this repeats on Row B with beams 53, 54 and 55 as well as 57, 58 and 59, or any beams in close proximity to these, then the parties are moving across the area of interest from Row A toward Row C. If long interruptions occur with no re-connection of the beams, based on the delay and calculations, system 1200 may determine whether someone is pushing a wheelchair or a stroller or shopping cart, etc. and the system can determine the appropriate counts and directions as well.

Similarly, if light beams 8, 9 and 10 in Row A are intenupted and then 48 and 50 in segment 5 of Row B along with 51 in segment 6 of Row B and then beam 90 in segment 9 of Row C along with beams 91 and 92 in segment 10, then the person being tracked is moving in a diagonal pattern from the left most entrance/exit point on the top toward the center left entrance/exit at the bottom. As another example, if five to seven beams are interrupted in close timing and proximity on segment 3 in Row A then segment 7 in Row B and then Segment 11 in Row C, then system 1200 may determine that two people side by side are walking in from the top the monitored area shown in FIG. 12 to the bottom of the area. As yet another example, if adjoining beam segments that are three beams units wide are interrupted in sequence in segment 12 in Row C, then segment 8 in Row B and then segment 4 in Row A, then one person is moving from the bottom of the monitored area to the entrance/exit at the top of the area.

By defining location, distance, timing and proximity of light beam interruptions along with relative positions and interruptions of other light beams, system 1200 can track and count people and/or asset flow in an area, and record and report the monitoring data in real-time.

In some embodiments, systems 100-500, 800-900, and 1200 may be configured to export and/or import data to another system. For example, system 300 may be connected to system 900, and data collected from system 300 may be exported to system 900 for counting and tracking people flow in an area of interest, such as a building, a mall, etc. Similarly, data collected 900 may be exported to another system for, e.g., targeted advertising, sending coupons to persons in a specified area, extracting purchase history data, or political opinions of persons in a certain area, etc.

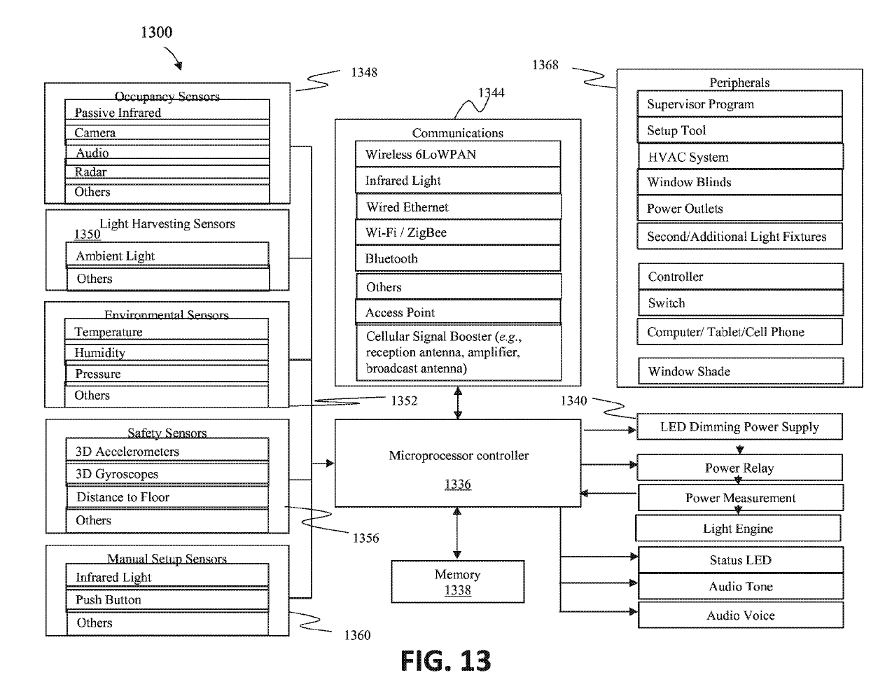

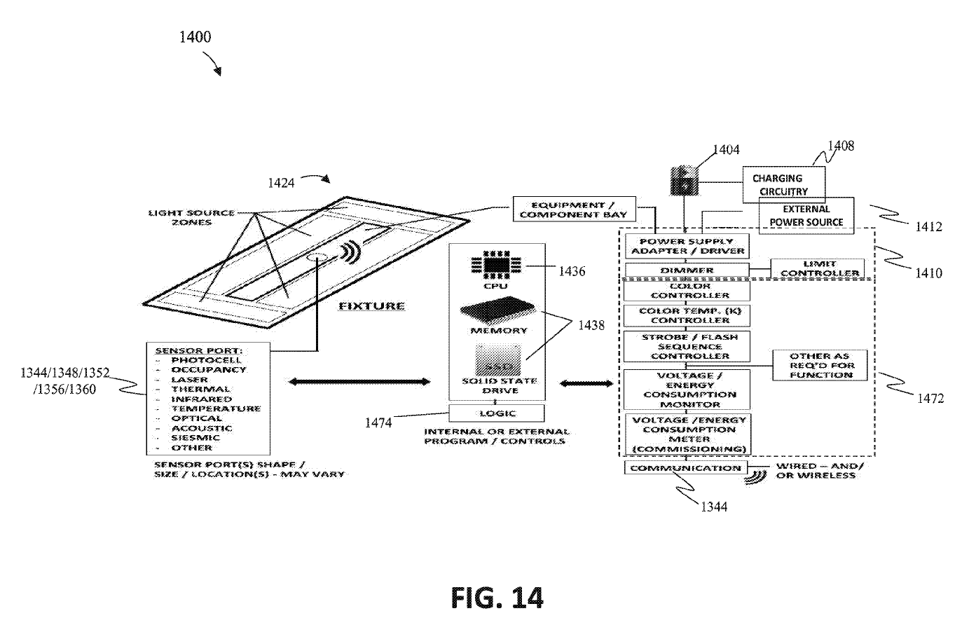

One or more of systems 100-500, 800-900, and 1200 may be connected to and export data to systems depicted in FIGS. 13-14. For example, system 500 described above may be connected to system 1300 depicted in FIG. 13, which may be a light fixtures configured to perform various functions, such as monitoring occupancy, temperature, humidity, pressure, and the like of an area (such as a room or building). With data imported from system 500, and in connection of other components, such as memory 1338 and processor 1336, system 1300 may be able to perform functions that are performed by system 500, such as detecting person entering/exiting a building, counting number of person entering/exiting/present in a building, etc. in some embodiments, any of the systems described above may be connected to another system described in the prior art and export data to the other system, and/or perform certain functions in connection with another system described in the prior art.

In some embodiments, one or more of systems 100-500, 800-900, and 1200 may be connected to and export data to system 1400 depicted in FIG. 14 (and/or systems that include multiples of the components depicted in FIG. 14, such as, for example, in the form of multiple interconnected light fixtures). For example, data exported from system 500 may be used in system 1400 to control the operation of transmitters/receivers in system 500, and power the transmitters/receivers using a battery 1404 and/or external power source 1412, under control of a charging circuitry 1408. In some embodiments, data imported from system 500 may be used by control components 1472, which may be separate components, or be unitary with processor 1436, to control the functioning of components in system 500, and/or used to assist other functions of system 1400, such as commissioning, performance monitoring, lumen maintenance, data collection, analysis, reporting, and/or the like.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1.-59. (canceled)

60. A method for quantifying flow of persons through an entrance point of a specified area, the method comprising:
transmitting, via a first planar array of photoelectric units disposed on a first side of the entrance point, a first array of light beams horizontally across the entrance point;
transmitting, via a second planar array of photoelectric units disposed on the first side of the entrance point, a second array of light beams at a non-horizontal, non-vertical angle across the entrance point;
detecting, by a processor coupled to the first planar array and the second planar array, an interruption of a portion of the first array of light beams;
detecting, by the processor, an interruption of a portion of the second array of light beams;
determining, by the processor and utilizing information obtained from the interruption of a portion of the first array of light beams and the interruption of a portion of the second array of light beams, whether the interruption was caused by a person passing through the entrance point; and
counting, by the processor, the number of persons passing through the entrance point during a specified period of time.

61. The method of claim 60, further comprising:
transmitting, via a third planar array of photoelectric units disposed on a second side of the entrance point and coupled to the processor, a third array of light beams at a non-horizontal, non-vertical angle across the entrance point;
detecting, by the processor, an interruption of a portion of the third array of light beams; and
determining, by the processor and utilizing information obtained from the interruption of the third array of light beams, whether the interruption was caused by a person passing through the entrance point.

62. The method of claim 61, wherein the first array of light beams, the second array of light beams, and the third array of light beams are planar, and wherein the plane of the first array of light beams is parallel to and non-overlapping with the plane of the second array of light beams and the plane of the third array of light beams.

63. The method of claim 60, wherein the first planar array of photoelectric units is disposed at a first distance from the entrance point, wherein the second planar array of photoelectric units is disposed at a second distance from the entrance point, and wherein the second distance is greater than the first distance.

64. The method of claim 60, wherein the light beams in the first array of light beams are parallel to one another, and wherein the light beams in the second array of light beams are non-parallel to one another.

65. The method of claim 60, wherein the first distance and the second distance differ from one another by a distance greater than the average width of a person.

66. The method of claim 60, wherein the first array of light beams comprises a wavelength that is invisible to a human eye.

67. The method of claim 60, wherein the first array of light beams and the second array of light beams comprise differing wavelengths.

68. The method of claim 60, further comprising communicating, by the processor and to an emergency responder, information regarding the number of persons passing through the access point during the specified period of time.

69. The method of claim 63, further comprising determining, by the processor and based on (i) the information obtained from the interruption of a portion of the first array of light beams, (ii) the interruption of a portion of the second array of light beams, and (iii) the distance between the plane of the first array of light beams and the plane of the second array of light beams, a moving direction of an object causing the interruption.

70. The method of claim 63, further comprising determining, by the processor and based on (i) the information obtained from the interruption of a portion of the first array of light beams, (ii) the interruption of a portion of the second array of light beams, and (iii) the distance between the plane of the first array of light beams and the plane of the second array of light beams, a speed of an object causing the interruption.

71. The method of claim 60, further comprising determining, by the processor, the interruption of a portion of the first array of light beams and the interruption of a portion of the second array of light beams are caused by different persons.

72. The method of claim 60, further comprising guiding a person to pass through the first array of light beams and the second array of light beams via use of a guiding structure.

73. The method of claim 60, wherein each photoelectric unit in the first planar array is configured to receive a reflected copy of the light beam generated by such photoelectric unit.

74. The method of claim 60, further comprising determining, by the processor and based on the interruption of a portion of the first array of light beams and the interruption of a portion of the second array of light beams, whether a person is entering the specified area or exiting the specified area.

75. A system for quantifying flow of persons through an entrance point of a specified area, the system comprising:
a first planar array of photoelectric units disposed on a first side of the entrance point;
a second planar array of photoelectric units disposed on the first side of the entrance point;
a memory; and
a processor coupled to the memory, the first planar array, and the second planar array, the processor configured to execute instructions from the memory to:
cause the first planar array of photoelectric units to transmit a first array of light beams horizontally across the entrance point;
cause the second planar array of photoelectric units to transmit a second array of light beams at a non-horizontal, non-vertical angle across the entrance point;
detect, by the processor, an interruption of a portion of the first array of light beams;
detect, by the processor, an interruption of a portion of the second array of light beams;
determine, by the processor and utilizing information obtained from the interruption of a portion of the first array of light beams and the interruption of a portion of the second array of light beams, whether the interruption was caused by a person passing through the entrance point; and
count, by the processor, the number of persons passing through the entrance point during a specified period of time.

76. The system of claim 75, wherein the first array of light beams and the second array of light beams are planar, and wherein the plane of the first array of light beams is parallel to and non-overlapping with the plane of the second array of light beams.

77. The system of claim 75, wherein the first planar array of photoelectric units is disposed at a first distance from the entrance point, wherein the second planar array of photoelectric units is disposed at a second distance from the entrance point, and wherein the second distance is greater than the first distance.

78. The system of claim 75, wherein the processor is further configured to execute instructions from the memory to:
cause a third planar array of photoelectric units disposed on a second side of the entrance point to transmit a third array of light beams at a non-horizontal, non-vertical angle across the entrance point;
detect, by the processor, an interruption of a portion of the third array of light beams; and
determine, by the processor and utilizing information obtained from the interruption of the third array of light beams, whether the interruption was caused by a person passing through the entrance point.

79. The system of claim 75, wherein the first array of light beams comprises a wavelength that is invisible to a human eye.
